(19) United States
(12) Patent Application Publication
(10) Pub. No.: US 2026/0223066 A1
(43) Pub. Date: Jul. 30, 2026

(54) METHODS FOR AMBIENT POWER-ENABLED IoT DEVICE POSITIONING IN WIRELESS SYSTEMS

(71) Applicant: InterDigital Patent Holdings, Inc., Wilmington, DE (US)

(72) Inventors: Guanzhou Wang, Brossard (CA); Michael Starsinic, Newtown, PA (US); Michel Roy, Candiac (CA); Saad Ahmad, Montreal (CA); Atle Monrad, Froland (FO)

(73) Assignee: InterDigital Patent Holdings, Inc., Wilmington, DE (US)

(21) Appl. No.: 19/147,551

(22) PCT Filed: Feb. 5, 2024
(86) PCT No.: PCT/US2024/014468

§ 371 Date: Jul. 11, 2025

Related U.S. Application Data
(60) Provisional application No. 63/444,332, filed on Feb. 9, 2023.

(51) Int. Cl. H04W 64/00

(52) U.S. Cl. CPC H04W 64/006

(57) ABSTRACT

A wireless transmit/receive unit (WTRU) may establish a connection with an ambient power-enabled internet of things (A_IoT) device. The WTRU may receive a location update request. For example, the WTRU may receive the location update request from the A_IoT device via the connection. The WTRU may send a mobile originated location request (MO-LR). The WTRU may send the MO-LR to a network, for example based on the received location update request. The MO-LR may include an identifier associated with the A_IoT device and/or an indication that positioning is requested for the A_IoT device. The WTRU may determine to perform positioning with the network. The WTRU may perform the positioning, for example with the network, to indicate the location of the A_IoT device. The connection may be a sidelink connection and/or a backscattering connection.

### CROSS-REFERENCE TO RELATED APPLICATIONS

This application claims the benefit of U.S. Provisional Application No. 63/444,332 filed on Feb. 9, 2023, the entire contents of which are incorporated herein by reference.

### BACKGROUND

An ambient power-enabled Internet of Things (IoT) device may be an IoT device that can harvest energy from the environment (e.g., wireless radio waves, motion, vibration, piezoelectricity, solar and wind power, etc.). An ambient power-enabled IoT (A_IoT) device may be battery-less and/or may have limited energy storage (e.g., using a capacitor). Ambient power-enabled IoT devices may be used in industrial wireless senor networks where, for example the environment may be harsh (e.g., extremely high or low temperature) and/or where devices may be battery-less, maintenance-free and/or have a long service life. These devices may additionally, or alternatively, play an important role in smart logistics and/or smart warehousing. Low-cost, small-form, battery-lessness, and/or durability may contribute to these devices suitability to be attached to (e.g., huge) amounts of goods and/or may facilitate more efficient goods identification, sorting, tracking and/or inventorying.

### SUMMARY

A wireless transmit/receive unit (WTRU) may be configured to transmit a first WTRU identifier to a second WTRU. The first WTRU may be a positioning companion WTRU (PC_WTRU). The second WTRU may be an ambient power-enabled internet of things (IoT) (A_Iot) device. The first WTRU may be configured to receive a second WTRU identifier associated with the second WTRU. The second WTRU identifier may be a sidelink identifier that includes one or more of a timestamp, a distance between the first WTRU and the second WTRU, and a WTRU identifier (e.g., permanent equipment identifier (PEI), 5G-GUTI, GPSI, application layer identifier, service identifier, etc.). The first WTRU may be configured to pair with the second WTRU. A pairing may be over PC5. For example, the pairing may be a PC5 based discovery and/or pairing. Additionally, or alternatively, the pairing may be based on the first WTRU identifier and/or the second WTRU identifier. The first WTRU may be configured to initiate a mobile originated location request (MO-LR) procedure. A MO-LR procedure message may be transmitted based on the MO-LR procedure. For example, the MO-LR request message (e.g., procedure message) may be transmitted to the network based on the MO-LR procedure.

The first WTRU may be configured to transmit a pairing report message to a network. The pairing report message may be transmitted to a network access and mobility function (AMF). The AMF may be configured to verify an MO-LR procedure. For example, the AMF may be configured to verify an MO-LR procedure based on the pairing report message. The MO-LR procedure may include one or more timestamps. The one or more timestamps may be associated with one or more second WTRUs. The MO-LR procedure may be requested by the second WTRU. The first WTRU may be configured to determine a distance between the first WTRU and the second WTRU. Additionally, or alternatively, the first WTRU may be configured to initiate the MO-LR procedure when the distance between the first WTRU and the second WTRU exceeds a threshold. The first WTRU and second WTRU may pair through a sidelink.

A WTRU (e.g., a positioning companion WTRU) may establish a connection with an A_IoT device. The WTRU may receive a location update request. For example, the WTRU may receive the location update request from the A_IoT device via the connection. The WTRU may send a MO-LR. The WTRU may send the MO-LR to a network, for example based on the received location update request. The MO-LR may include an identifier associated with the A_IoT device and/or an indication that positioning is requested for the A_IoT device. The WTRU may determine to perform positioning with the network, for example to indicate that the positioning procedure (e.g., MO-LR procedure) is associated with (e.g., for) the A_IoT device. The WTRU may perform the positioning, for example with the network, to indicate the location of the A_IoT device. For example, the positioning procedure may enable the network to estimate the location of the A_IoT device (e.g., based on positioning measurements of the WTRU). The connection may be a sidelink connection and/or a backscattering connection.

The MO-LR may additionally, or alternatively, include one or more of a timestamp associated with a communication between the WTRU and the A_IoT device, an estimated distance between the WTRU and the A_IoT device, an application identifier, and/or a service identifier. The WTRU may receive one or more location update requests from a plurality of A_IoT devices, for example within a predefined period of time. The MO-LR may include identifiers of each of the plurality of A_IoT devices. The location indicated during positioning with the network may be associated with the plurality of A_IoT devices.

The WTRU may send pairing information to the network. The pairing information may indicate that the WTRU comprises a positioning companion WTRU and/or that the A_IoT device has delegated location services to the WTRU. The indication that positioning is requested for the A_IoT device may include a positioning companion flag. The WTRU may send a (e.g., second) MO-LR to the network. The (e.g., second) MO-LR may include an estimated distance between the WTRU and the A_IoT device. The estimated distance between the WTRU and the A_IoT device may be associated with a threshold. The WTRU may send the (e.g., second) MO-LR to the network based on the estimated distance between the WTRU and the A_IoT device exceeding the threshold. The WTRU may receive a mobile terminated location request (MT-LR), for example from the network.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example non-roaming reference architecture for location services in 5G.

FIG. 3 is a diagram illustrating an example high-level procedure of an ambient power-enabled internet of things (A_IoT) device positioning using a positioning companion WTRU (PC_WTRU).

FIG. 4 is a diagram illustrating an example mobile originated location request (MO-LR) procedure using a PC_WTRU.

### DETAILED DESCRIPTION

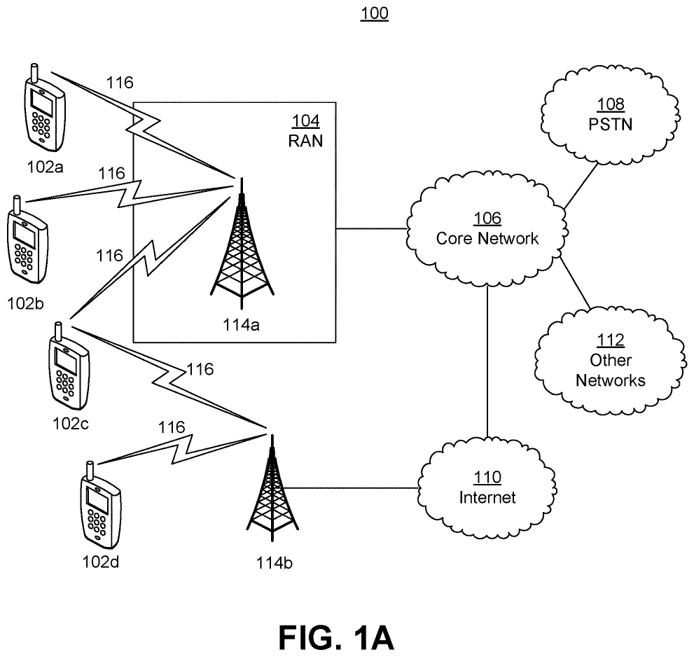

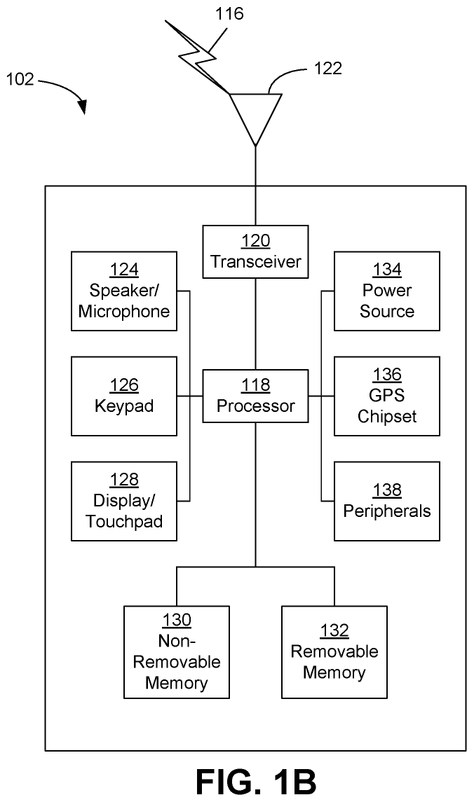

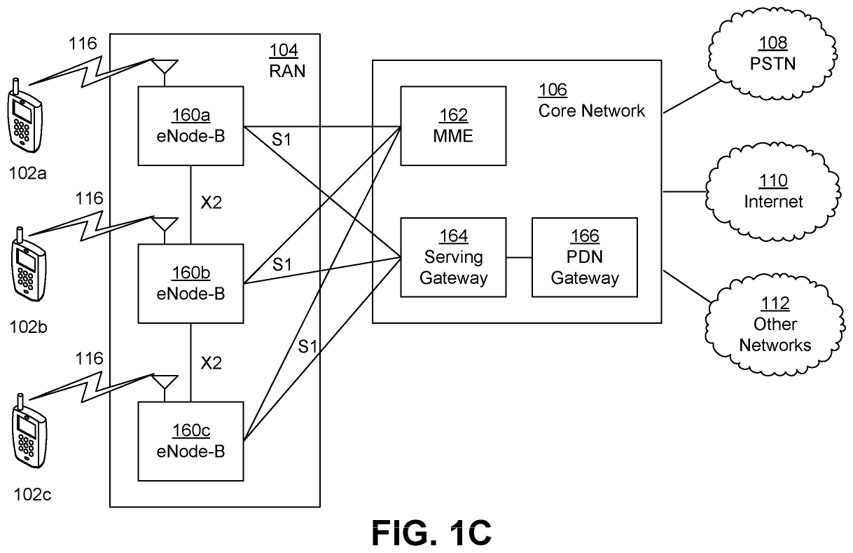

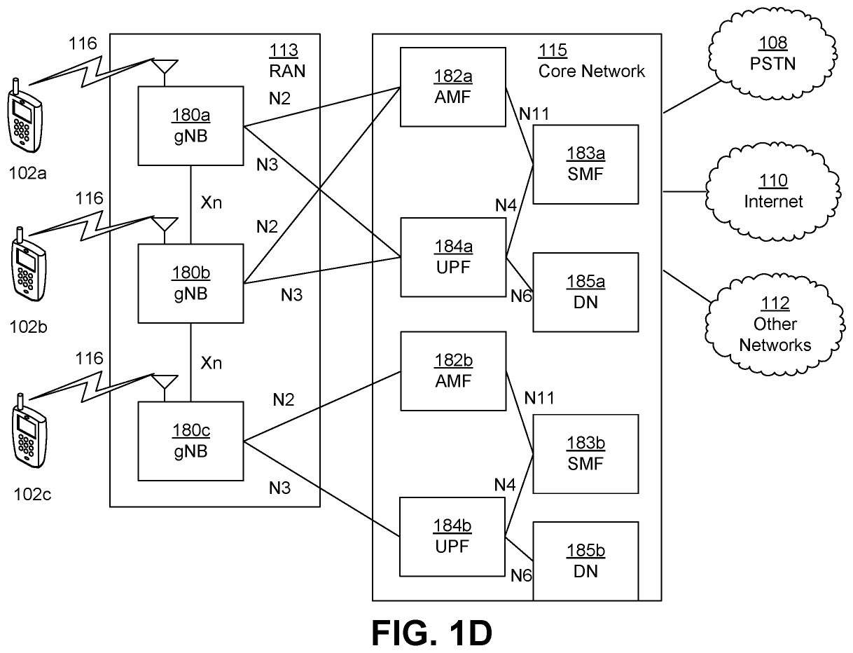

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A wireless transmit/receive unit (WTRU) may be configured to transmit a (e.g., first) WTRU identifier to another (e.g., a second) WTRU. The (e.g., first) WTRU may be a positioning companion WTRU (PC_WTRU). The other (e.g., second) WTRU may be an ambient power-enabled internet of things (IoT) (A_IoT) device. The (e.g., first) WTRU may be configured to receive another (e.g., a second) WTRU identifier. The sidelink identifier may include and/or be associated with one or more of a timestamp, a distance between the (e.g., first) WTRU and the other (e.g., second) WTRU, and/or a WTRU identifier. The WTRU identifier may include and/or be associated with one or more of a permanent equipment identifier (PEI), 5G-GUTI, GPSI, application layer identifier, service identifier, and/or etc. The (e.g., first) WTRU may be configured to pair with the other (e.g., second) WTRU. A pairing may include PC5 (e.g., a PC5 interface). For example, the pairing may include a PC5 based discovery and/or pairing. Additionally, or alternatively, the pairing may be based on the (e.g., first) WTRU identifier and/or the other (e.g., second) WTRU identifier. The (e.g., first) WTRU may be configured to initiate a mobile originated location request (MO-LR) procedure. A MO-LR procedure message may be transmitted based on the MO-LR procedure. For example, the MO-LR procedure message may be transmitted to the network based on the MO-LR procedure.

The (e.g., first) WTRU may be configured to transmit a pairing report message to a network. The pairing report message may be transmitted to a network access and mobility function (AMF). The AMF may be configured to verify an MO-LR procedure. For example, the AMF may be configured to verify an MO-LR procedure based on the pairing report message. The MO-LR procedure may include one or more timestamps. The one or more timestamps may be associated with one or more other (e.g., second) WTRUs. The MO-LR procedure may be requested by the other (e.g., second) WTRU. The (e.g., first) WTRU may be configured to determine a distance between the (e.g., first) WTRU and the sidelink WTRU. Additionally, or alternatively, the (e.g., first) WTRU may be configured to initiate the MO-LR procedure, for example when the distance between the (e.g., first) WTRU and the other (e.g., second) WTRU exceeds a threshold. The threshold may be preconfigured. The (e.g., first) WTRU and the other (e.g., second) WTRU may pair through a sidelink.

A WTRU may establish a connection with an A_IoT device. The WTRU may receive a location update request. For example, the WTRU may receive the location update request from the A_IoT device via the connection. The WTRU may send a MO-LR. The WTRU may send the MO-LR to a network, for example based on the received location update request. The MO-LR may include an identifier associated with the A_IoT device and/or an indication that positioning is requested for the A_IoT device. The WTRU may determine to perform positioning with the network, for example to indicate a location of the A_IoT device. The WTRU may perform the positioning, for example with the network, to indicate that the positioning procedure (e.g., MO-LR procedure) is associated with (e.g., for) the A_IoT device. For example, the positioning procedure may enable the network to estimate the location of the A_IoT device (e.g., based on positioning measurements of the WTRU). The connection may be a sidelink connection and/or a backscattering connection. Additionally, or alternatively, the connection between the WTRU and the A_IoT device may utilize one or more of Bluetooth, Bluetooth low energy (BLE), short range wireless communication, ultra high frequency (UHF) communication, and/or another type of communication.

The MO-LR may additionally, or alternatively, include one or more of a timestamp associated with a communication between the WTRU and the A_IoT device, an estimated distance between the WTRU and the A_IoT device, an application identifier, and/or a service identifier. The WTRU may receive one or more location update requests from a plurality of A_IoT devices, for example within a predefined period of time. The MO-LR may include identifiers of each of the plurality of A_IoT devices. The location indicated during positioning with the network may be associated with the plurality of A_IoT devices.

The WTRU may send pairing information to the network. The pairing information may indicate that the WTRU comprises a positioning companion WTRU and/or that the A_IoT device has delegated location services to the WTRU. The indication that positioning is requested for the A_IoT device may include a positioning companion flag. The WTRU may send a (e.g., second) MO-LR to the network. The (e.g., second) MO-LR may include an estimated distance between the WTRU and the A_IoT device. The estimated distance between the WTRU and the A_IoT device may be associated with a threshold. The WTRU may send the (e.g., second) MO-LR to the network based on the estimated distance between the WTRU and the A_IoT device exceeding the threshold. The WTRU may receive a mobile terminated location request (MT-LR), for example from the network.

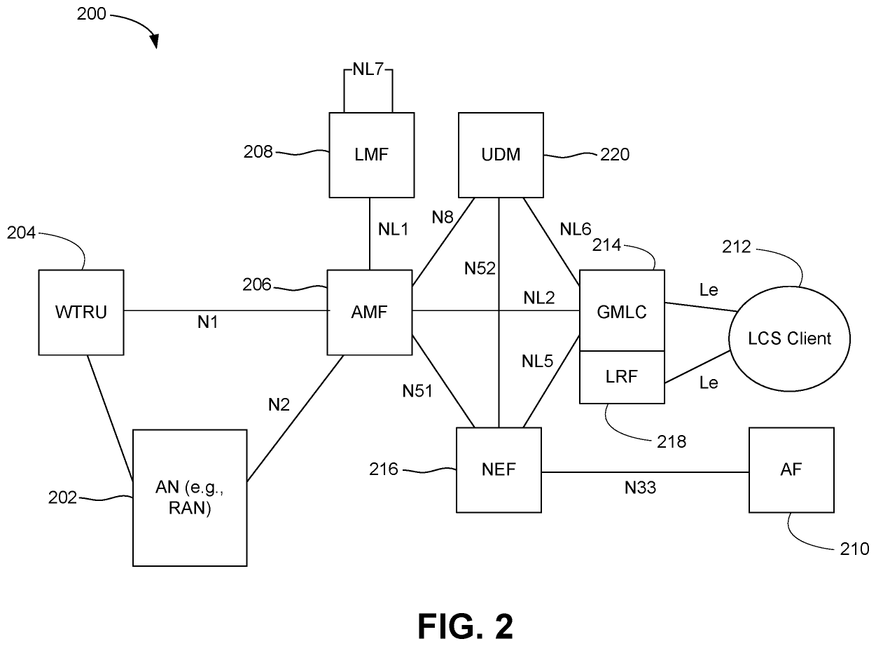

FIG. 2 depicts an example non-roaming reference architecture 200. The non-roaming reference architecture 200 may support location services. For example, the reference architecture 200 may support location services in 5G. A WTRU positioning measurement may be performed. The WTRU and/or one or more network nodes may perform the WTRU positioning measurement. For example, the WTRU positioning measurement may be performed between the WTRU and a location management function (LMF). Additionally, or alternatively, one or more other nodes may be utilized in the positioning measurement (e.g., AMF and/or NG-RAN). Location information may be provided to a location service (LCS) client, for example through a gateway mobile location center (GMLC) and/or a network exposure function (NEF).

The non-roaming reference architecture 200 may include a WTRU 204. The WTRU 204 may send and/or receive location information. For example, location information may be sent and/or received between an access control and mobility management function (AMF) 206 or location management function (LMF) 208 and the (e.g., target) WTRU 204, or the like. An AF 210 and/or NF may access LCS from a gateway mobile location center (GMLC) 214, for example in the same 3GPP operator network. An LCS client 212 may access LCS from a GMLC 214. An external AF 210 may access LCS from a network exposure function (NEF) 216. A GMLC 214 may be configured to handle one or more of the request from an external LCS client 212, an AF via a NEF 216 if the AF is an external AF, or forward a location request to a proper NF. A location retrieval function (LRF) 218 may be configured to retrieve or validate location information. The LRF 218 may be collocated with a GMLC 214 or separate from the GMLC 214. A LMF 208 may manage (e.g., overall) coordination and/or scheduling of resources (e.g., required) for the location of a WTRU 204 that is registered with or is accessing a 5GCN. The LMF 208 may calculate and/or verify (e.g., final) location related information and/or (e.g., achieved) accuracy. One or more of an LMF 208, LRF 218, and GMLC 214 may be included as network function(s) of a 5CGN.

Two types of location service procedures may be supported for example. The types of supported location services may include mobile originated location request (MO-LR) and/or mobile terminated location request (MT-LR). In MO-LR, the WTRU may initiate the procedure with a serving network and/or use the procedure to obtain the location of itself (e.g., the WTRU). In MT-LR, the procedure may be initiated by the LCS client. Alternatively, or additionally, the network may bring the target WTRU to connected mode, for example to perform positioning measurements and/or to provide the WTRU's location to the LCS client.

An A_IoT device may play a key role, for example where timely and/or relatively precise positioning of the A_IoT device may be required. For example, an A_IoT device may be utilized in one or more of asset tracking, smart logistics, lost item recovery, and/or etc. An A_IoT device may not include a battery and/or may be power constrained. The lack of a battery and/or the (e.g., extremely) power-constrained nature of A_IoT devices may result in the A_IoT device being unreachable in a wireless network (e.g., for a significant time). For example, an A_IoT device may not be able to respond and/or perform WTRU positioning procedure. The A_IoT device may not be able to respond when a location service client (e.g., an application server or a WTRU) requests (e.g., needs) to retrieve its location, for example through the wireless network. The network may provide a last-known location and/or defer the location measurement. Additionally, or alternatively, the network may report until the device becomes reachable again. The time that an A_IoT device may become reachable may be unpredictable and/or may depend on device capabilities and/or the time needed to harvest enough energy. A deferred location report may not satisfy one or more requirements of a use case.

The A_IoT device may have one or more reduced WTRU capabilities (e.g., for cost saving). Additionally, or alternatively, an A_IoT device may not support WTRU positioning capabilities and/or perform location measurements. Some existing location service mechanisms may not be utilized for positioning with an A_IoT device. One or more methods and/or enhancements may assist an A_IoT device and/or existing location service mechanism, which for example may enable the wireless network to locate (e.g., relatively precise) device positions (e.g., in a timely manner).

A positioning companion WTRU (PC_WTRU) may be provided. An A_IoT device (e.g., a power constrained A_IoT device) may delegate one or more location services to the PC_WTRU. For example, the PC_WTRU may not be power-constrained. The network may determine and/or consider the location of the A_IoT to be the same or close to (e.g., within a threshold from) the location of the PC_WTRU.

When the A_IoT delegates one or more location services to a PC_WTRU, the A_IoT device may not need to communicate with the wireless network and/or perform heavy-load signaling procedures for its location update. Additionally, or alternatively, the network may obtain a location estimation (e.g., a usable location estimation) of the A_IoT device, for example, when the A_IoT device and the PC_WTRU are close together.

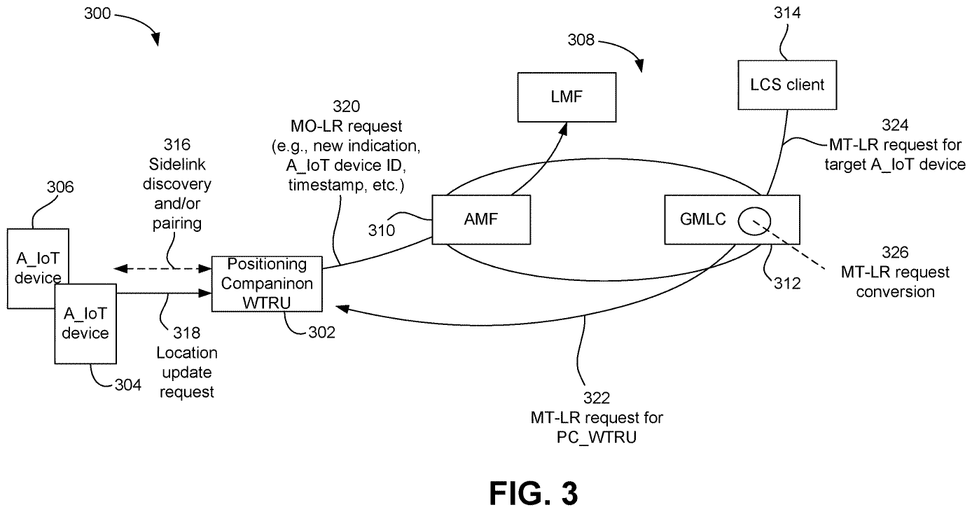

FIG. 3 illustrates an example procedure 300 of A_IoT device positioning using a PC_WTRU 302. A PC_WTRU 302 may be a WTRU and/or device that is in close proximity of an A_IoT device 304, 306 (e.g., a target A_IoT device). At 316, there may be sidelink discovery and/or pairing between the target A_IoT device 304, 306 and the PC_WTRU 302. At 318, the PC_WTRU 302 may receive a location update request from the A_IoT device 304, 306. The target A_IoT device 304, 306 may be tracked and/or positioned (e.g., from time to time) by a network 308. The PC_WTRU 302 may not be power constrained (e.g., as power constrained as the A_IoT device 304, 306). The PC_WTRU 302 may be able to remain connected and/or reachable with the serving wireless network 308. The PC_WTRU 302 may be configured to communicate with the wireless network 308 and at the same time configured to establish communications (e.g., communicate and/or pair) with the adjacent A_IoT device 304, 306, for example using sidelink technologies (e.g., PC5 based discovery and/or communication). Example PC_WTRUs 302 may include one or more of a phone (e.g., of a vehicle driver or passenger) and/or a vehicle (e.g., with which the goods and/or parcels with A_IoT based tags may be transported). The PC_WTRU 302 may establish sidelink communications with the A_IoT device 304, 306, for example by sidelink discovery and/or pairing. Sidelink discovery and/or pairing may include one or more proximity services/procedures. Additionally, or alternatively, the PC_WTRU 302 may establish communications with (e.g., communicate) with an A_IoT device 304, 306 through backscattering, Bluetooth, Bluetooth low energy (BLE), short range wireless communication, ultra high frequency (UHF) communication, and/or another type of communication.

One or more A_IoT devices 304, 306 may be configured to discover and/or pair with a WTRU (e.g., adjacent WTRU) as a PC_WTRU 302 for the one or more A_IoT devices 304, 306, for example in the sidelink. The pairing of the one or more A_IoT devices 304, 306 and the PC_WTRU 302 may be reported to the serving network 308 (e.g., AMF 310 in the network). The A_IoT device 304, 306 may request the PC_WTRU 302 to initiate a MO-LR procedure with the network 308 (e.g., the GMLC 312 in the network). The network 308 may store the location of the PC_WTRU 302 as the location of the A_IoT device 304, 306 (e.g., a target A_IoT device). The location request for one or more target A_IoT devices 304, 306 may be converted to a location request for the PC_WTRU 302 (e.g., at 326) that, for example may be paired with the one or more A_IoT devices 304, 306. The network 308 may initiate the MO-LR (e.g., at 320) and/or MT-LR (e.g., at 322) procedure with the PC_WTRU 302. The network 308 may store the results of the MO-LR and/or MT-LR procedure, for example as the location of the target A_IoT device 304, 306 (e.g., at 324). The network and/or the PC_WTRU may determine (e.g., assume) that the location of the PC_WTRU is the location of the A_IoT device.

An A_IoT device 304, 306 may be pre-configured for A_IoT device positioning, for example using a PC-WTRU 302. For example, the A_IoT device 304, 306 may include configuration information. The configuration information may indicate that the A_IoT device 304, 306 should discover and/or pair with a nearby PC_WTRU 302. For example, an A_IoT device 304, 306 that may be (e.g., closely) tracked and/or does not have location service capabilities may be pre-configured for A_IoT device positioning using a PC_WTRU 302. An A_IoT device 304, 306 may receive configuration information and/or a configuration indication from the serving network (e.g., AMF in the network). The configuration information and/or configuration indication may be received by the A_IoT device 304, 306, for example when the A_IoT device 304, 306 communicates with the network during a registration procedure. The A_IoT device 304, 306 may identify one or more opportunities to discover and pair with a PC_WTRU 302, confirm a paired PC_WTRU 302, and/or update an existing paired PC_WTRU 302, for example when the A_IoT device 304, 306 is preconfigured for A_IoT device positioning using the PC_WTRU 302. The one or more opportunities may include one or more of when the device has harvested enough energy to complete such a task (e.g., an energy threshold is reached), before and/or after the device has completed communication with the network, expiration of a (e.g., locally) configured periodic timer, and/or etc.

The A_IoT device 304, 306 may use sidelink (e.g., certain sidelink) and/or point-to-point communication technologies (e.g., LTE/NR PC5), for example to discover and/or pair with the PC_WTRU 302. The A_IoT device 304, 306 may be pre-configured with one or more authorization policies, one or more valid candidate PC_WTRU identifiers (e.g., layer-2 identifiers for PC5 based communication, permanent equipment identifier (PEI), etc.), and/or one or more security profiles (e.g., necessary security profiles). The PC_WTRU 302 may be pre-configured with the one or more authorization policies, one or more valid A_IoT device identifiers (e.g., layer-2 identifiers for PC5 based communication, PEls, etc.), and/or the one or more security profiles (e.g., necessary security profiles). The A_IoT device 304, 306 and the PC_WTRU 302 may obtain (e.g., receive) and/or store the identifiers of the peer device. For example, the A_IoT device 304, 306 and the PC_WTRU 302 may obtain and store the identifiers of the peer device through the discovery and/or pairing process. For example, the A_IoT device 304, 306 may obtain a 3GPP WTRU identifier (e.g., PEI, 5G-globally unique temporary identifier (GUTI), etc.), an external identifier (e.g., generic public subscription identifier (GPSI)), and/or an application layer identifier of the paired PC_WTRU 302.

The PC_WTRU 302 may maintain a list of active A_IoT devices 304, 306. For example, the PC_WTRU 302 may maintain a list of active A_IoT devices that utilize (e.g., rely on) the PC_WTRU 302 for location services. The A_IoT device 304, 306 and/or the PC_WTRU 302 may report pairing information (e.g., the associated identifiers of A_IoT device 304, 306 and PC_WTRU device 302) to the serving network 308. For example, the A_IoT device 304, 306 and/or the PC_WTRU 302 may report the pairing information to the serving network when the A_IoT device 304, 306 and/or PC_WTRU 302 have the opportunity to communicate with the serving network. The serving network 308 may store the pairing information in network functions and/or databases (e.g., AMF, Visiting-gateway mobile location centre (V-GMLC), Home-GMLC (H-GMLC), UDM, etc.). The network functions and/or databases may use the information for one or more location service procedures.

An A_IoT device 304, 306 may request the PC_WTRU 302 to report the location of the A_IoT device 304, 306 to the network 308. For example, after the A_IoT device 304, 306 has paired with the PC_WTRU 302, the A_IoT device 304, 306 may request the PC_WTRU 302 (e.g., using sidelink communication and/or backscattering) to report the location of the A_IoT device 304, 306 to the network 308. The request may be made (e.g., immediately) after the initial pairing and/or when (e.g., each time) the A_IoT device 304, 306 becomes active again. The PC_WTRU 302 may initiate an MO-LR procedure as herein (e.g., upon this request).

The PC_WTRU 302 may initiate a MO-LR procedure as described herein. The PC_WTRU 302 may indicate its role of positioning companion and/or indicate that the location request may be performed for one or more dependant WTRUs/devices (e.g., such as A_IoT devices 304, 306), for example that the PC_WTRU 302 has paired with. The PC_WTRU 302 may send a list of A_IoT device identifiers to the network 308. The list may include an indication of the device(s) that the PC_WTRU 302 has paired with and/or has requested the location service. Device identifiers may be associated with one or more of a timestamp, range information, an identifier of an application that the device is associated with, and/or an identifier of a service that the device is associated with. The timestamp which may indicate the latest time that the PC_WTRU 302 has performed a hand-shake (e.g., over sidelink) with the A_IoT device 304, 306. The range information may include an estimation of the distance between the PC_WTRU 302 and the A_IoT device 304, 306. The network may use the identifier of the application and/or service, for example to determine the LCS client 314 that should receive the location update.

At 320, the PC_WTRU 302 may send a MO-LR request. The AMF 310 may retrieve the pairing information from the UDM and/or compare the existing pairing information with the list of A_IoT devices 304, 306 (e.g., in the MO-LR request), for example after receiving the MO-LR request and/or recognizing that the request is performed on behalf of other WTRUs. In some examples, the UDM may not possess the pairing information.

The AMF 310 may include an indication that the location update is for (e.g., associated with) other dependant WTRUs/devices and/or may include one or more of the identifiers of the dependant WTRUs/devices, the associated timestamp, range information, and/or associated application/service. For example, when the AMF 310 initiates the location update request with the GMLC 312, the AMF 310 may include the indication that the location update is for other dependant WTRUs/devices and/or may include one or more of the identifiers of the dependant WTRUs/devices, the associated timestamp, range information, and/or associated application/service.

The GMLC 312 may determine whether to notify the potential LCS client 314 about the location update, for example for each (e.g., individual dependent) WTRU. Additionally, or alternatively, the GMLC 312 may determine (e.g., if needed) the receiving LCS client 314 address information and/or send the location update to the LCS client 314 (e.g., directly or through NEF). The LCS client 314 address information may be based on (e.g., may be determined based on) the dependant WTRU's associated application/service information.

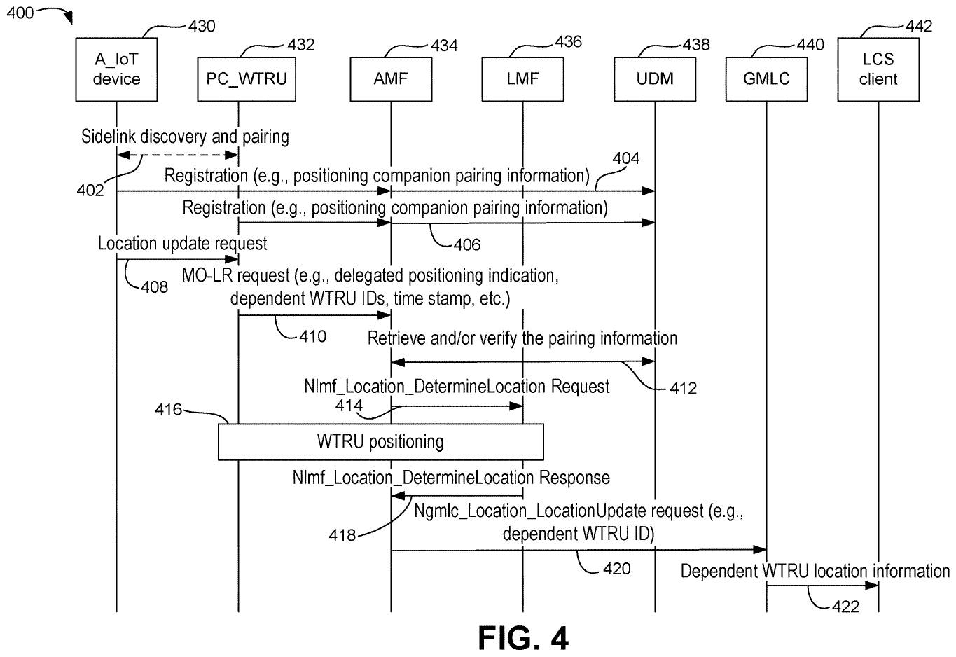

FIG. 4 illustrates an example MO-LR procedure 400 using a PC_WTRU 432. For example, the MO-LR procedure 400 may enable the network to store the location of an A_IoT device 430 using the PC_WTRU 432. At 402, the PC_WTRU 432 may establish communications with the A_IoT device 430. The non-roaming reference architecture 400 may be used for A_IoT device positioning using the PC_WTRU 432. For example, at 402, the A_IoT device 430 and the PC_WTRU 432 may discover and/or pair with each other using sidelink discovery and/or communication procedures. For example, proximity service (ProSe) Model A and/or B discovery may be used. The A_IoT device 430 may be pre-configured with an authorization policy and/or one or more parameters for discovery (e.g., ProSe restricted code, discovery query filter, ProSe response code, and/or etc.). For example, the A_IoT device 430 may be pre-configured with authorization policy and/or necessary parameters for discovery so that the A_IoT device 430 does not have to request the authorization and/or obtain those parameters from the network.

The A_IoT device 430 may additionally, or alternatively, be pre-configured with candidate PC_WTRU identifiers (e.g., destination L2 identifier). The candidate PC_WTRU identifiers may be associated with establishing communication with one or more candidate PC_WTRUs. For example, the communication may include sidelink and/or backscattering. The A_IoT device 430 and the PC_WTRU 432 may exchange 3GPP identifiers (e.g. PEI, 5G-GUTI, etc.) and/or external identifiers (e.g., GPSI, application layer identifier, etc.). For example, the A_IoT device 430 and the PC_WTRU 432 may exchange 3GPP identifiers and/or external identifiers over sidelink communication. The A_IoT device 430 may inform the PC_WTRU 432 of the application and/or service identifier that the A_IoT device 430 is associated with. The A_IoT device 430 and/or the PC_WTRU 432 may store the identifier of the paired device. The PC_WTRU 432 may maintain a list of multiple paired A_IoT devices. The PC_WTRU 432 may store the timestamp (e.g., when the pairing occurs). Sidelink discovery and/or pairing may be repeated (e.g., periodically and/or when it is possible/when the A_IoT device 430 has enough energy in store to perform such a task). The A_IoT device 430 and/or the PC_WTRU 432 may update one or more of stored pairing info and/or associated timestamp, and application/service info (e.g., upon each handshake).

At 404, the A_IoT device 430 may send a registration message to the network (e.g., the UDM 438). At 406, the PC_WTRU 432 may send a registration message to the network (e.g., the UDM 438). The registration message (e.g., from the A_IoT device 430 at 404 and/or from the PC_WTRU 432 at 406) may indicate positioning companion paring information). At 404 and/or 406, the A_IoT device 430 and/or the PC_WTRU 432 may report the pairing information, for example to the network (e.g., during a registration procedure). The A_IoT device 430 and/or the PC_WTRU 432 may indicate to the network that the pairing information is for a location service delegation purpose. The network may store the pairing information in one or more network functions (e.g., serving AMF 434, UDM 438, and/or GMLC 440). In some examples, pairing information may not be sent immediately after sidelink discovery and/or pairing.

One or more of the following may be performed before and/or after pairing information is sent to the network. At 408, the A_IoT device 430 may request the PC_WTRU 432 to perform a location update for the A_IoT device 430 (e.g. over sidelink communication). The A_IoT device 430 may indicate to the PC_WTRU 432 the application and/or service identifier that it is associated with.

At 410, the PC_WTRU 432 may initiate a MO-LR procedure. For example, the PC_WTRU 432 may initiate, at 410, the MO-LR procedure to update the location for the A_IoT device 430. The PC_WTRU 432 may initiate the MO-LR procedure upon receiving the A_IoT device request at 406, and/or upon its own decision. For example, the PC_WTRU 432 may run a periodic timer after pairing with the A_IoT device 430 and/or may initiate the location update upon timer expiry. Additionally, or alternatively, the PC_WTRU 432 may determine that the distance the PC_WTRU 432 has moved since last location update has exceeded a certain threshold (e.g., a predetermined threshold) and/or that a location update is required. The PC_WTRU 432 may include information, for example in the MO-LR request. The request may be for location service delegation (e.g., the purpose of the request may be to update the location for other dependent WTRUs and/or the A_IoT devices). The location of the requesting WTRU (e.g., the PC_WTRU) may be determined to be (e.g., considered as) the location of one or more other dependent WTRUs and/or the A_IoT devices. The information may include one or more of one or more identifiers of the dependent WTRUs, timestamp information (e.g., when the PC_WTRU has confirmed pairing and/or handshake with the dependent WTRU and/or may be used to indicate the freshness of the location of the dependent WTRU) associated with the dependent WTRU, and/or an application and/or service associated with the dependent WTRU.

The application and/or service associated with the dependent WTRU may be used by the network, for example to locate the LCS client that may be (e.g., needs to be) notified of the dependent WTRU's location. Additionally, or alternatively, the MO-LR may include an indication that positioning is being requested for one or more A_IoT devices. The indication may include a positioning companion flag.

At 412, the AMF 434 may retrieve the information (e.g., from the UDM 438) and/or verify the information included in the MO-LR request. The AMF 434 may retrieve the information (e.g., from the UDM 438) and/or use it to verify the information included in the MO-LR request, for example if the pairing information is available in the network.

At 414, the AMF 434 may select the LMF 436 and/or invoke a Nlmf_Location_DetermineLocation service of the LMF 436. For example, the AMF may send, at 414, a location request (e.g., a Nlmf_Location_DetermineLocation request) to the LMF 436.

At 416, one or more WTRU positioning procedures may be performed (e.g., as described herein) for the LMF 436 to determine the location of the PC_WTRU 432. For example, the PC-WTRU 432 may perform positioning (e.g., a positioning measurement) with the network (e.g., the LMF 436) at 416 to indicate that the positioning procedure (e.g., MO-LR) is associated with (e.g., for) the A_IoT device 430. For example, the positioning procedure may enable the network (e.g., the LMF 436) to estimate the location of the A_IoT device 430 (e.g., based on positioning measurements of the PC_WTRU 432). The location of the PC_WTRU 432 determined via the positioning performed, at 416, may indicate the location of the A_IoT device 430. For example, the network (e.g., the LMF 436) may determine the location of the A_IoT device 430 based on the location of the PC_WTRU 432 determined via the positioning performed at 416. For example, the network (e.g., the LMF 436) may assume that the location of the A_IoT device 430 is the same as the location of the PC_WTRU 432.

At 418, the LMF 436 may send (e.g., return) the Nlmf_Location_DetermineLocation response to the AMF 434, for example in response to the NLmf_Location_DetermineLocation service request sent at 414.

At 420, the AMF 434 may select and/or invoke the Ngmlc_Location_LocationUpdate service operation to the GMLC 440. For example, the AMF 434 may send, at 420, a location update request to the GMLC 440. The service operation may include the identity and/or multiple identities of the dependent WTRUs (e.g., instead of or in addition to PC_WTRUs). The location information may additionally, or alternatively, include the location of the PC_WTRU 432.

At, 422, the GMLC 440 may send (e.g., forward) the location information to an LCS client 442 (e.g., the application server) that, for example may request (e.g., need) the information. Sending (e.g., at 422) the location information to the LCS client 442 may utilize (e.g., involve) a NEF notification service.

The MO-LR procedure may be performed in any order. Additionally, or alternatively, one or more steps of the MO-LR procedure may be repeated. Additionally, or alternatively, one or more steps of the MO-LR procedure may be omitted.

The PC_WTRU may combine requests and/or initiate a single MO-LR procedure for multiple A_IoT devices, for example when multiple A_IoT devices issue location requests (e.g., around the same time). For example, the PC_WTRU may combine requests and/or initiate a single MO-LR procedure for multiple A_IoT devices. The PC_WTRU may additionally, or alternatively, include the identifier(s) of paired A_IoT device(s). For example, the PC_WTRU may include the identifiers of paired A_IoT devices that have not requested (e.g., explicitly requested) a location update (e.g., if the PC_WTRU has a chance to initiate MO-LR procedure with the network).

The PC_WTRU may have one or more active paired A_IoT devices relying on it for location service. The PC_WTRU may start a periodic timer and/or initiate an MO-LR procedure as described herein, for example upon the expiry of the timer. The PC_WTRU may start a periodic timer and/or initiate an MO-LR procedure without explicit requests from dependant A_IoT devices. Additionally, or alternatively, an A_IoT device may be paired to one or more PC_WTRU.

The network (e.g., the GMLC) may convert a location service request from an external client for a target A_IoT device to a location request for the PC_WTRU, for example based on the stored pairing information between the target A_IoT device and the PC_WTRU. The network may receive a location service request, for example a mobile terminated location request. The network (e.g., the GMLC) may convert the location service request for a (e.g., target) A_IoT device to a location request for the PC_WTRU, for example based on the stored pairing information between the target A_IoT device and the PC_WTRU. Additionally, or alternatively, the network may determine (e.g., consider) the PC_WTRU's location to be the target A_IoT device's location and/or report the location to the external client.

The A_IoT device may receive the PC_WTRU's location information during the sidelink communication and/or handshake procedure. The A_IoT device may compare the current PC_WTRU location with a previously received PC_WTRU location (e.g., to estimate/determine the distance it has moved). If the distance exceeds a certain threshold for example, the A_IoT device may initiate one or more of a direct MO-LR procedure with the network and/or a location update (e.g., using the PC_WTRU as described herein). A threshold may be one or more of pre-configured in the device and/or configured by the network. The PC_WTRU may determine its position using its own global navigation satellite system (GNSS) receiver and/or using the location service procedures. For example, the PC_WTRU may determine its position using its own GNSS receiver and/or using the location service procedures, for example as described herein.

There may be a location tracking priority mode (e.g., for the PC_WTRU and/or the A_IoT device). In a location tracking priority mode for example, the A_IoT device may seek opportunities (e.g., frequent opportunities) to initiate a location update with the network and/or prioritize a location update procedure over other service procedures. The network may maintain a location (e.g., a relatively fresh last-known location) of the A_IoT device, and/or be configured to provide a (e.g., last-known) location (e.g., a usable last-known location). For example, the network may maintain a location (e.g., a relatively fresh last-known location) of the A_IoT device, and/or be able to provide a (e.g., last-known) location (e.g., a usable last-known location) when there is a mobile terminated location request from the LCS client and/or if the device is not reachable.

An A_IoT WTRU/device may be pre-configured and/or configured by the network to be working in a location tracking priority mode. The network may, for example based on the subscription and/or application server request, determine that the WTRU should be (e.g., closely) tracked, and/or may determine to send an indication and/or configuration to the A_IoT WTRU. For example, during a registration procedure, the network may, based on the subscription and/or application server request, determine that the WTRU should be (e.g., closely) tracked, and/or may determine to send an indication and/or configuration to the A_IoT WTRU.

The A_IoT WTRU may seek an opportunity (e.g., every opportunity) to initiate a location update procedure (e.g., direct MO-LR procedure with the network, and/or a location update using the PC_WTRU), for example in a location tracking priority mode. For example, the WTRU may initiate a procedure when it has harvested enough energy (e.g., reached a threshold) to support the location update procedure. Additionally, or alternatively, the WTRU may embed the location update procedure within one or more other procedures with the network (e.g., registration, service request, and/or etc.). For example, when the WTRU has completed another service procedure and/or has residue energy that can support location update procedure, the WTRU may initiate the location update procedure. Additionally, or alternatively, the A_IoT device may prioritize the location update procedure over other communication needs. The WTRU may perform the location update procedure first before sending the data, for example if the WTRU becomes available for communication with the network and/or if the WTRU has some data to send to the network. The WTRU may be additionally, or alternatively, configured (e.g., by the network) with a distance threshold. The WTRU may initiate (e.g., only initiate) a location update procedure (e.g., in location tracking priority mode), for example when the moved distance has exceeded the threshold. The terms WTRU, A_IoT device, and UE may be used interchangeably herein.

What is claimed is:

1-20. (canceled)

21. A method implemented by a wireless transmit/receive unit (WTRU), the method comprising:
establishing a connection with an ambient internet of things (A_IoT) device;
receiving a location update request from the A_IoT device via the connection;
sending a mobile originated location request (MO-LR) to a network based on the received location update request, wherein the MO-LR comprises an identifier associated with the A_IoT device and an indication that positioning is requested for the A_IoT device; and
performing positioning with the network.

22. The method of claim 21, wherein the MO-LR further comprises one or more of a timestamp associated with a communication between the WTRU and the A_IoT device, an estimated distance between the WTRU and the A_IoT device, an application identifier, or a service identifier.

23. The method of claim 21, further comprising receiving location update requests from a plurality of A_IoT devices within a predefined period of time, wherein the MO-LR comprises identifiers of each of the plurality of A_IoT devices, and wherein a location indicated during positioning with the network is associated with the plurality of A_IoT devices.

24. The method of claim 21, further comprising sending pairing information to the network, wherein the pairing information indicates that the WTRU is a positioning companion WTRU and that the A_IoT device has delegated location services to the WTRU.

25. The method of claim 21, wherein performing positioning with the network comprises performing a positioning measurement with the network that enables the network to estimate a location of the A_IoT device.

26. The method of claim 21, wherein the indication that positioning is requested for the A_IoT device comprises a positioning companion flag.

27. The method of claim 21, wherein establishing a connection with the A_IoT device comprises establishing a sidelink (SL) connection.

28. The method of claim 21, wherein the MO-LR is a first MO-LR, wherein the method further comprising sending a second MO-LR to the network, and wherein the second MO-LR comprises an estimated distance between the WTRU and the A_IoT device.

29. The method of claim 28, wherein the estimated distance between the WTRU and the A_IoT device is associated with a threshold, and wherein the second MO-LR is sent to the network based on the estimated distance between the WTRU and the A_IoT device exceeding the threshold.

30. The method of claim 21, further comprising receiving a mobile terminated location request (MT-LR) from the network.

31. A wireless transmit/receive unit (WTRU) comprising a processor, the processor configured to:
establish a connection with an ambient internet of things (A_IoT) device;
receive a location update request from the A_IoT device via the connection;
send a mobile originated location request (MO-LR) to a network based on the received location update request, wherein the MO-LR comprises an identifier associated with the A_IoT device and an indication that positioning is requested for the A_IoT device; and
perform positioning with the network.

32. The WTRU of claim 31, wherein the MO-LR further comprises one or more of a timestamp associated with a communication between the WTRU and the A_IoT device, an estimated distance between the WTRU and the A_IoT device, an application identifier, or a service identifier.

33. The WTRU of claim 31, wherein the processor is further configured to receive location update requests from a plurality of A_IoT devices within a predefined period of time, wherein the MO-LR comprises identifiers of each of the plurality of A_IoT devices, and wherein a location indicated during positioning with the network is associated with the plurality of A_IoT devices.

34. The WTRU of claim 31, wherein the processor is further configured to send pairing information to the network, wherein the pairing information indicates that the WTRU is a positioning companion WTRU and that the A_IoT device has delegated location services to the WTRU.

35. The WTRU of claim 31, wherein the processor configured to perform the positioning with the network comprises the processor being configured to perform a positioning measurement with the network that enables the network to determine a location of the A_IoT device.

36. The WTRU of claim 31, wherein the indication that positioning is requested for the A_IoT device comprises a positioning companion flag.

37. The WTRU of claim 31, wherein the processor configured to establish a connection with the A_IoT device comprises the processor being further configured to establish a sidelink (SL) connection.

38. The WTRU of claim 31, wherein the MO-LR is a first MO-LR, wherein the processor is further configured to send a second MO-LR to the network, and wherein the second MO-LR comprises an estimated distance between the WTRU and the A_IoT device.

39. The WTRU of claim 38, wherein the estimated distance between the WTRU and the A_IoT device is associated with a threshold, and wherein the processor is configured to send the second MO-LR to the network based on the estimated distance between the WTRU and the A_IoT device exceeding the threshold.

40. The WTRU of claim 31, wherein the processor is further configured to receive a mobile terminated location request (MT-LR) from the network.
